(19) United States
(12) Patent Application Publication
(10) Pub. No.: US 2007/0066296 A1
(43) Pub. Date: Mar. 22, 2007

(54) Method and apparatus for providing information

(76) Inventors: Alasdair Craig Scott-Goddard, London (GB); Simon James O'Regan, Bedfordshire (GB)

Correspondence Address: SILBER & FRIDMAN, 1037 ROUTE 46 EAST, SUITE 207, CLIFTON, NJ, 07013, US

(21) Appl. No.: 11/231,916

(22) Filed: Sep. 21, 2005

(51) Int. Cl. H04Q 7/20

(52) U.S. Cl. 455/422.1

(57) ABSTRACT

A method and apparatus for providing information to a portable wireless device. The method comprises the steps of: arranging apparatus including a storage device, a transmitter and an antenna to define a zone of coverage; storing information in the storage device; detecting a portable wireless device within the defined zone; requesting the portable wireless device for permission to send information; if consent is received from the portable wireless device, sending the information stored in the storage device to the portable wireless device, and if consent is not received from the portable wireless device, not sending said stored information.

### FIELD OF THE INVENTION

This invention relates to a method and apparatus for providing information to portable wireless devices, and in particular for providing such information using a Bluetooth connection.

### BACKGROUND OF THE INVENTION

The availability of portable devices able to receive information through a wireless connection, such as mobile phones and personal digital assistants (PDA) has steadily increased for many years and this increase is expected to continue for the foreseeable future. Further, such portable devices are now small and light enough that many users carry them at most, or all, times.

There are many known techniques for the users of portable wireless devices to obtain desired information, for example by accessing websites through the internet. However, these known techniques rely on the user desiring and requesting access to, or actively seeking out, the information.

It would clearly be commercially useful to be able to provide or send information to users through their portable devices without the user needing to initiate the process. However, known techniques for doing this are not satisfactory.

Although email or text (SMS) messages can potentially be broadcast from a central source to large numbers of user portable devices, the cost of mass sending of SMS messages is usually prohibitive. This approach also has the disadvantage that, in most cases, the information in the messages will be of no interest to most of the users. As a result the messages are regarded as a nuisance by most users receiving them and they are ignored or blocked in the same way as junk email, generally referred to as spam.

This is expected to be a particular problem if the portable device used the very popular Bluetooth type wireless connection. This is because the Bluetooth protocol has the option of requiring user consent before a file can be downloaded and displayed. If users expect or fear being sent nuisance messages they will simply not give such consent.

It is an object of the present invention to provide a method of providing information to selected portable wireless devices and so overcome these problems, at least in part.

### SUMMARY OF THE INVENTION

In a first aspect, this invention provides, a method of providing information to a portable wireless device, the method comprising the steps of:

arranging apparatus including a storage device, a transmitter and an antenna to define a zone of coverage;

storing information in the storage device;

detecting a portable wireless device within the defined zone;

requesting the portable wireless device for permission to send information;

if consent is received from the portable wireless device, sending the information stored in the storage device to the portable wireless device, and

if consent is not received from the portable wireless device, not sending said stored information.

In a second aspect, this invention provides, apparatus for providing information to a portable wireless device, the apparatus comprising:

a transmitter and an antenna defining a zone of coverage,

a storage device containing stored information,

a detection device arranged to detect a portable wireless device within the defined zone;

a request device arranged to request the portable wireless device for permission to send information;

a control device arranged to send the information stored in the storage device to the portable wireless device if consent is received from the portable wireless

device, and not to send said stored information if consent is not received from the portable wireless device.

### BRIEF DESCRIPTION OF THE DRAWINGS

Preferred embodiments of the invention will now be described, by way of example only, with reference to the accompanying figures, in which:

FIG. 1 shows an information providing apparatus according to a first embodiment of the invention;

FIG. 2 shows an information providing apparatus according to a second embodiment of the invention; and

FIG. 3 shows an information providing system according to the invention.

### DESCRIPTION OF THE PREFERRED EMBODIMENTS

In a first embodiment of the invention, first, a location or area is identified where information is to be provided to users through portable wireless devices 1 carried by the users, such as mobile phones, laptop computers or PDA's.

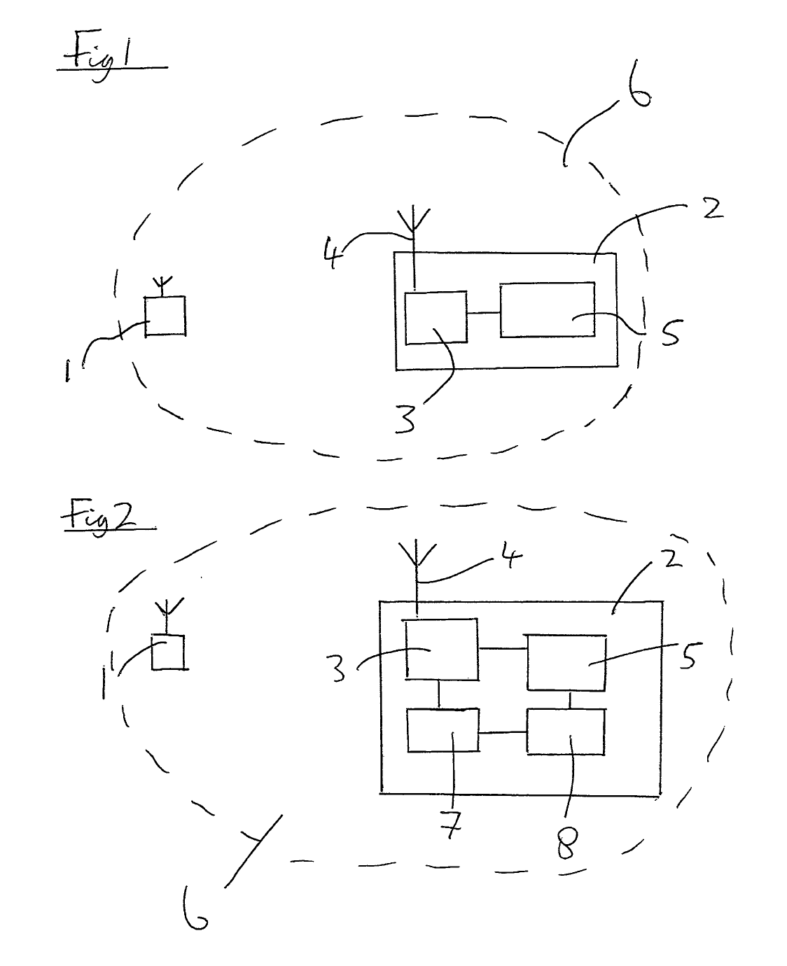

Next, an information providing apparatus 2 as shown in FIG. 1 is arranged at the location. The information providing apparatus 2 comprises a Bluetooth compatible transmitter 3 and antenna 4 and an information storage means 5. Information which it is desired to send to users as Bluetooth messages are stored in the information storage means 5.

The transmitter 3 and antenna 4 cooperate to define a zone 6 within which the system can communicate with and send messages to a Bluetooth enabled portable wireless device 1. The zone 6 is preferably defined to be a sphere with a radius of between 25 and 100 meters in clear air. However, in practice the size and shape of the zone will be influenced by the surrounding terrain and buildings.

The size and shape of the zone 6 will depend on the properties of the selected transmitter 3 and antenna 4. In order to allow the zone 6 to be set to the desired size and shape the properties of the antenna 4 and transmitter 3 may be adjustable. Usually it will be simplest to do this by adjusting the transmit power of the transmitter 3.

The setting of a zone radius in the range 25 to 100 meters is not essential. However, this is preferred.

When a user carrying a portable wireless device 1 which is Bluetooth enabled and has been set by the user to be Bluetooth device discoverable, that is a portable wireless device 1 having its Bluetooth function switched on, enters the zone 6 the apparatus 2 detects and contacts the portable wireless device 1, and requests permission to send a message.

Depending upon the operating options supported by the portable wireless device 1 and/or selected by the user, The portable wireless device 1 may automatically accept the message or the portable wireless device 1 may ask the user whether the proposed incoming message should be accepted. If the message is accepted, whether automatically or by the user, the message is sent from the apparatus 2 to the portable wireless device 1 and the information contained in the message can be reviewed by the user. Alternatively, if the user declines, the message is not sent.

The apparatus 2 according to the invention allows the information sent to the user to be limited to information expected to be relevant to users in the zone 6. For example, the information can be advertising information about products, services or special offers available at retail sites in or close to the zone. In another example the information can be service information about public transport which can be boarded in or near the zone. In this case the zone could contain a tram or bus stop or a train or bus station entrance. In a further example the information can be advertising information linked to advertising on a poster or other display in, or visible from, the zone.

Thus, information is only supplied to users in a defined area who are likely to find the information useful or of interest. As a result, the chance that users will consent to receive the information, and review it after receipt, are increased and the risk that users will refuse consent or ignore the information is reduced.

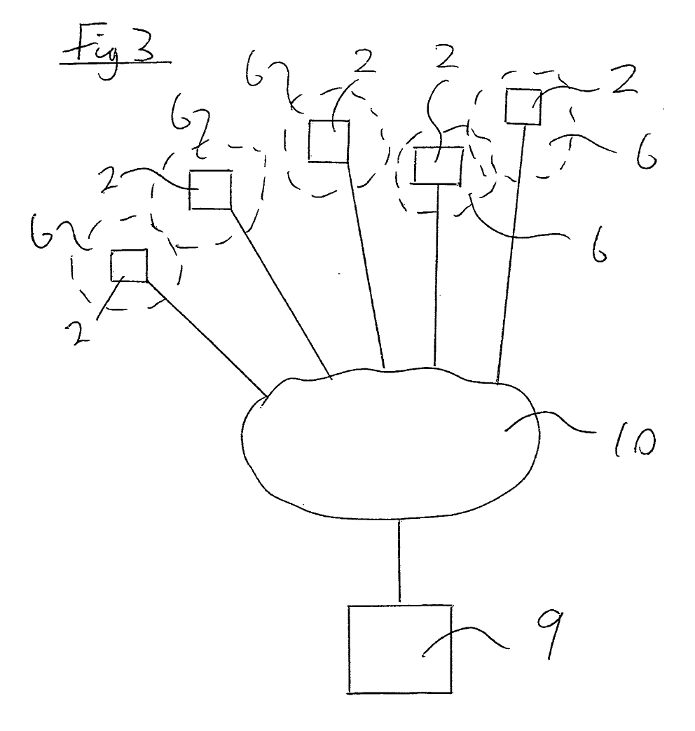

In a second embodiment of the invention, as shown in FIG. 2, the apparatus 2 further comprises identification means 7 and control means 8. When the apparatus 2 detects a portable wireless device 1, the identification means 7 obtains the unique Bluetooth identification number of the portable wireless device 1.

In a first mode of operation of the second embodiment, if the user declines acceptance, the control means 8 stores this identification number in a declining device number storing part of the information storage means 5.

In the first mode, when a portable wireless device 1 is detected the identification number obtained by the identification means 7 is compared by the control means 8 with the declining device numbers stored in the information storage means 5. If there is a match, permission to send a message is not requested.

By use of the first mode, users who have declined receiving a message are not subsequently bothered with a further requests. As a result, undesirable annoyance of users is avoided.

In a second mode of operation of the second embodiment of the invention, the control means 8 also stores the identification numbers of portable wireless devices 1 which do accept messages together with the identity of the information sent in an accepting device number storage part of the information storage means 5.

In the second mode, when a portable wireless device 1 is detected the identification number obtained by the identification means 7 is compared by the control means 8 with the accepting device numbers stored in the information storage means 5. If there is a match showing that the intended information has already been sent to that user, permission to send a message is not requested.

By use of the second mode, users who have already received a message are not subsequently bothered with a further copies of the same message. As a result, undesirable annoyance of users is avoided.

It should be understood that avoiding annoying users with unwanted or duplicate information is generally desirable in order to foster and maintain user tolerance of the system and avoid systematic blocking or refusal of messages.

In both of the above embodiments the apparatus 2 further includes a clock and can be arranged to operate differently at different times. For example, messages including information about retail sites could be sent only when the retail sites are open, or different information regarding public transport schedules can be sent at different times. Further, in the second embodiment, the stored declining device numbers and/or accepting device numbers can be deleted after a set period so that the non sending of messages after a user has declined a message or received identical information is for a set period rather than being permanent.

In a most preferred arrangement the apparatus 2 of the second embodiment is able to operate in both of the described modes and includes a clock, and the control means 8 is able to be programmed to apply the different features of the apparatus 2 in different ways for different information.

In this arrangement, the control means 8 applies programmable rules to the sending, or attempted sending of information, which may be different for different items of information.

The rules can include scheduling rules, selection rules and delivery rules. Examples of scheduling rules include start and stop times for sending information, and how frequently the same information should be sent. Examples of selection rules include what information should be sent on particular days or at particular times, and the sequence in which different information should be sent. Examples of delivery rules include the message protocol, what types of devices the information should be delivered to, and whether, or when, further information should be sent after a user declines a message. These rule examples are not exhaustive.

Delivery rules regarding the types of device to be delivered to can be used to prevent attempts to send information to devices unable to display it.

Selection rules regarding sequence can be used to send a series of advertising information to each user in the correct order.

In a third embodiment shown in FIG. 3, an information distribution system is formed by a server 9 is connected through a network 10 to a plurality of apparatuses 2. Typically the network 10 is the internet, but this is not essential. The apparatuses 2 are arranged at different locations to serve different zones 6. Different ones of the different zones 6 may be separated from one another, adjacent to one another or overlap one another, as desired.

The server 9 can update the apparatuses 2 in the system by sending new information and/or new rules to the apparatuses 2. Further, the server 9 can maintain a record of user interaction across the whole system so that the rules, such as scheduling rules, selection rules and delivery rules are applied across the entire system.

Instead of a central server 9 the system could be decentralised and formed by a plurality of networked apparatuses only.

In addition to the uses of the invention described above, a number of further uses are envisaged.

The information sent to a user portable wireless device by the apparatus may be paid for by the user. This can be implemented by selling scratch cards bearing number codes to users and the apparatus enabling the downloading of desired information to a user portable wireless device in response to receipt of a valid code. The operation of such scratch card based systems for purchasing telephone talk time is well known. Alternatively the apparatus 2 could be integrated with other payment means such as EPOS or a coin operated system.

One possible arrangement would be for a poster site to be in a zone, and the associated apparatus 2 being able to sell and download products advertised on the poster, such as music tracks or games software.

User preferences or interests could be recorded on the system and used to control the sending of individually tailored information to the users uniquely numbered portable wireless device. For example information that a shop relevant to a user hobby is nearby. This could even be used to provide a dating service by informing users with compatible interests of each others proximity.

The apparatus could allow a user portable wireless device to play games, or access the internet through the apparatus, using the Bluetooth link. In this case the information sent to a user portable wireless device could be an invitation to play or surf the net, or game software.

If a system according to the third embodiment is set up in a retail location it could be arranged to track users a compile profiles of their activity and movements for market research purposes. In order to provide useful information this will usually require a large number of apparatus with small zones arranged to contact or overlap.

A similar but larger scale arrangement could follow, or send, users from zone to zone across a city.

Further, information on user preferences gathered by the system, either directly by questioning or indirectly by inference, for example from music download requests, can be used to build up a user profile. The profile can then be used to select suitable products and services to offer to the user. The profile could also be used to control interaction with the user, such as playing preferred music in their vicinity.

The information sent to a user portable wireless device could be menus and/or directories allowing users to select further information such as movie trailers for downloading.

The apparatus could interconnect users, for example to enable the playing of multiplayer interactive games on user portable wireless devices, or to allow an audience to vote on the quality of a live performance. In this case the information sent to a user portable wireless device could be an invitation to play or vote.

The information sent to a user portable wireless device could include live, real time streaming content.

The apparatus could provide a voice over IP connection for a user portable wireless device.

The above description refers to use of the Bluetooth protocol. This is a convenient protocol for use in the invention, and as is explained above, the Bluetooth protocol suffers from specific problems which can be overcome by the invention. However use of the Bluetooth protocol is not essential and other protocols can be used in the invention, including, but not limited to, Wi-Fi, Wi-Max, GPRS, UMTS CMDA and FOMA.

We claim:

1. A method of providing information to a portable wireless device, the method comprising the steps of:
arranging apparatus including a storage device, a transmitter and an antenna to define a zone of coverage;
storing information in the storage device;
detecting a portable wireless device within the defined zone;
requesting the portable wireless device for permission to send information;
if consent is received from the portable wireless device, sending the information stored in the storage device to the portable wireless device, and
if consent is not received from the portable wireless device, not sending said stored information.

2. A method according to claim 1, including the further step of, after detecting a portable wireless device, obtaining the identity of the portable wireless device.

3. A method according to claim 2, in which, if consent is not received the identity of the non-consenting portable wireless device is stored.

4. A method according to claim 3, including the further step of, after obtaining the identity of the portable wireless device, comparing said identity to the stored identities of non-consenting portable wireless devices, and, if said portable wireless device is identified as a non-consenting portable wireless device, not requesting the portable wireless device for permission to send information.

5. A method according to claim 4, in which the stored identities of non-consenting portable wireless devices are deleted after a predetermined time.

6. A method according to claim 2, in which, if information is sent, the identity of the receiving portable wireless device and of the information sent is stored.

7. A method according to claim 6, including the further step of, after obtaining the identity of the portable wireless device, comparing said identity to the stored identities of receiving portable wireless devices, and, if said portable wireless device is identified as a receiving portable wireless device which has received the same information, not requesting the portable wireless device for permission to send information.

8. A method according to claim 7, in which the stored identities of receiving portable wireless devices are deleted after a predetermined time.

9. A method according to claim 1, in which different information is sent at different times.

10. Apparatus for providing information to a portable wireless device, the apparatus comprising:
a transmitter and an antenna defining a zone of coverage,
a storage device containing stored information,
a detector arranged to detect a portable wireless device within the defined zone;
a requesting device arranged to request the portable wireless device for permission to send information;
a controller arranged to send the information stored in the storage device to the portable wireless device if consent is received from the portable wireless device, and to not send said stored information if consent is not received from the portable wireless device.

11. Apparatus according to claim 10, including identifying means arranged to obtain the identity of the portable wireless device.

12. Apparatus according to claim 11, in which the controller is arranged to store the identity of the non-consenting portable wireless device if consent is not received.

13. Apparatus according to claim 12, and further comprising a comparator which compares said identity to the stored identities of non-consenting portable wireless devices, and, if said portable wireless device is identified as a non-consenting portable wireless device, the requesting device does not request permission to send information from the portable wireless device.

14. Apparatus according to claim 13, and further comprising a clock, in which the controller is arranged to delete the stored identities of non-consenting portable wireless devices after a predetermined time.

15. Apparatus according to claim 11, in which the controller is arranged to store the identity of the receiving portable wireless device and of the information sent if information is sent.

16. Apparatus according to claim 15, and further comprising a comparator which compares said identity to the stored identities of receiving portable wireless devices, and, if said portable wireless device is identified as a receiving portable wireless device for said information, the requesting device does not request permission to send information from the portable wireless device.

17. Apparatus according to claim 16, and further comprising a clock, in which the controller is arranged to delete the stored identities of receiving portable wireless devices and of the information sent after a predetermined time.

18. Apparatus according to claim 10, and further comprising a clock, in which the controller is arranged to send different information at different times.
